(19) United States
(12) Patent Application Publication
(10) Pub. No.: US 2025/0053724 A1
(43) Pub. Date: Feb. 13, 2025

(54) SYSTEM AND METHOD FOR INFERRING USER INTENT AND PERSONALIZATION OF USER INTERFACE

(71) Applicant: JPMorgan Chase Bank, N.A., New York, NY (US)

(72) Inventors: Brenda NG, Danville, CA (US); Apoorv CHAUDHARY, Hayward, CA (US); David JACOBS, Crystal Lake, IL (US); Jake COONEY, Chicago, IL (US); Daniel F RODRIGUEZ, Chicago, IL (US)

(73) Assignee: JPMorgan Chase Bank, N.A., New York, NY (US)

(21) Appl. No.: 18/231,511

(22) Filed: Aug. 8, 2023

(51) Int. Cl. G06F 40/106; G06F 40/14; G06F 40/166

(52) U.S. Cl. CPC G06F 40/106; G06F 40/14; G06F 40/166

(57) ABSTRACT

A method and system for dynamically customizing a webpage layout according to webpage transition history of a user are disclosed. The method includes collecting historical web session data of a plurality of users, and performing collaborative filtering using the collected historical web session data. The method further includes generating a probabilistic model and a webpage transaction path for a target user among the plurality of users. Then, the method further identifies one or more communities within the webpage transaction path, generates at least one recommendation and shortcut, and modifies a default webpage layout to include the at least one recommendation and the at least one shortcut.

### TECHNICAL FIELD

This disclosure generally relates to a system and method for inferring a user's intent and personalizing user interface for the respective user. More specifically, this disclosure relates to a system and method for modifying a user interface display based on inference of user intent as indicated by select historical data.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Presently, when a user visits or logs into a website or portal, the user may be provided with various actions that may be taken by the user for preforming a desired transaction. While efforts are expanded to design and implement a web portal that may be intuitive to navigate and utilized for a large population base, such a web portal may still be difficult or cumbersome for some users to navigate through. Such difficulties may lead to unnecessary time duration spent on the website or portal and resulting in unnecessary increase in network traffic, as well as additional support that may be required, such as via chat, email or phone.

### SUMMARY

According to an aspect of the present disclosure, a method for customized modification of a user interface according to a determination of user intent is provided. The method includes collecting, via a network, historical web session data of a plurality of users; storing, in a memory, the collected historical web session data; executing, by a processor, collaborative filtering using the collected historical web session data; generating, by the processor executing a machine learning (ML) algorithm, a probabilistic model; generating, by the processor, a webpage transaction path for a target user among the plurality of users; identifying, by the processor, one or more communities within the webpage transaction path; generating, by the processor, at least one webpage recommendation for the target user based on the collaborative filtering; generating, by the processor, at least one webpage shortcut for the target user based on the probabilistic model and the identified one or more communities within the webpage transaction path; modifying, by the processor, a default webpage layout to include the at least one webpage recommendation and the at least one webpage shortcut; and displaying, on a display, the modified webpage layout including the at least one webpage recommendation and the at least one webpage shortcut.

According to another aspect of the present disclosure, the method further includes categorizing of webpages visited in the historical web session data according to a webpage type into a plurality of categories of webpages; and combining the plurality of categories of webpages for generating a unique identifier.

According to another aspect of the present disclosure, the method further includes categorizing of webpages visited in the historical web session data according to a product type into a plurality of categories of products; and combining the plurality of categories of products for generating a unique identifier.

According to yet another aspect of the present disclosure, the method further includes formatting the collected historical web session data into a ML-ready sequence data for processing for the ML model.

According to another aspect of the present disclosure, the processing for the ML includes generating the ML model, training the ML model and updating the ML model.

According to a further aspect of the present disclosure, the modifying of the default webpage layout includes inserting a section to include the at least one webpage recommendation.

According to yet another aspect of the present disclosure, the modifying of the default webpage layout includes inserting a section to include the at least one webpage shortcut.

According to a further aspect of the present disclosure, the at least one webpage recommendation or the at least one webpage shortcut is provided as a hyperlink or a menu option.

According to another aspect of the present disclosure, the at least one webpage shortcut is generated based on identification of redundancies within the one or more communities, and the at least one webpage shortcut is configured to allow the target user to navigate directly to a webpage corresponding to the at least one webpage shortcut without visiting intervening webpages.

According to a further aspect of the present disclosure, the webpage transaction path includes a sequential order in which a plurality of webp ages were visited by the target user.

According to a further aspect of the present disclosure, the webpage transaction path is formed of a plurality of nodes, each of the plurality of nodes corresponding to each of the plurality of webpages visited by the target user in sequence.

According to a further aspect of the present disclosure, the one or more communities are identified based on proximate distances between adjacent nodes among the plurality of nodes.

According to a further aspect of the present disclosure, the webpage transaction path indicates a probability of transitioning from one node to another node among the plurality of nodes.

According to a further aspect of the present disclosure, the method further includes: calculating scores of frequency distribution of webpages visited by the target user; generating a user-webpage matrix based on the calculated scores; and calculating a similarity matrix based on the generated user-webpage matrix for generating the at least one webpage recommendation.

According to a further aspect of the present disclosure, the generating of the probabilistic model includes: generating a transition matrix of the target user based on the historical web session data; creating a weighted graph for computing a probable journey using the transition matrix; and generating a graph displaying traversals that characterizes the target user's webpage usage.

According to a further aspect of the present disclosure, the at least one webpage recommendation includes a webpage that the target user has not yet visited but another user in the similarity matrix has.

According to a further aspect of the present disclosure, the webpage that the target user has not yet visited provides information for a product.

According to a further aspect of the present disclosure, the at least one webpage recommendation is selected for recommendation based on its score.

According to an aspect of the present disclosure, a system to provide for dynamically customizing a webpage layout according to webpage transition history of a user is provided. The system includes a memory, a display and a processor. The processor is configured to perform: collecting, via a network, historical web session data of a plurality of users; storing the collected historical web session data; executing collaborative filtering using the collected historical web session data; generating, via a machine learning (ML) algorithm, a probabilistic model; generating a webpage transaction path for a target user among the plurality of users; identifying one or more communities within the webpage transaction path; generating at least one webpage recommendation for the target user based on the collaborative filtering; generating at least one webpage shortcut for the target user based on the probabilistic model and the identified one or more communities within the webpage transaction path; modifying a default webpage layout to include the at least one webpage recommendation and the at least one webpage shortcut; and displaying, on a display, the modified webpage layout including the at least one webpage recommendation and the at least one webpage shortcut.

According to another aspect of the present disclosure, a non-transitory computer readable storage medium that stores a computer program for dynamically customizing a webpage layout according to webpage transition history of a user is provided. The computer program, when executed by a processor, causes a system to perform multiple processes including: collecting, via a network, historical web session data of a plurality of users; storing the collected historical web session data; executing collaborative filtering using the collected historical web session data; generating, via a machine learning (ML) algorithm, a probabilistic model; generating a webpage transaction path for a target user among the plurality of users; identifying one or more communities within the webpage transaction path; generating at least one webpage recommendation for the target user based on the collaborative filtering; generating at least one webpage shortcut for the target user based on the probabilistic model and the identified one or more communities within the webpage transaction path; modifying a default webpage layout to include the at least one webpage recommendation and the at least one webpage shortcut; and displaying, on a display, the modified webpage layout including the at least one webpage recommendation and the at least one webpage shortcut.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an automated user interface personalization system (AUIPS) in accordance with an exemplary embodiment.

FIG. 2 illustrates an exemplary diagram of a network environment with an AUIPS in accordance with an exemplary embodiment.

FIG. 3 illustrates a system diagram for implementing an AUIPS in accordance with an exemplary embodiment.

FIG. 4 illustrates a process for providing an automated user interface personalization in accordance with an exemplary embodiment.

FIGS. 5A-5C illustrate a process for performing collaborative filtering in accordance with an exemplary embodiment.

FIGS. 6A-6D illustrate a process for performing probabilistic modeling and community detection in accordance with an exemplary embodiment.

FIG. 7 illustrates a personalized web portal in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

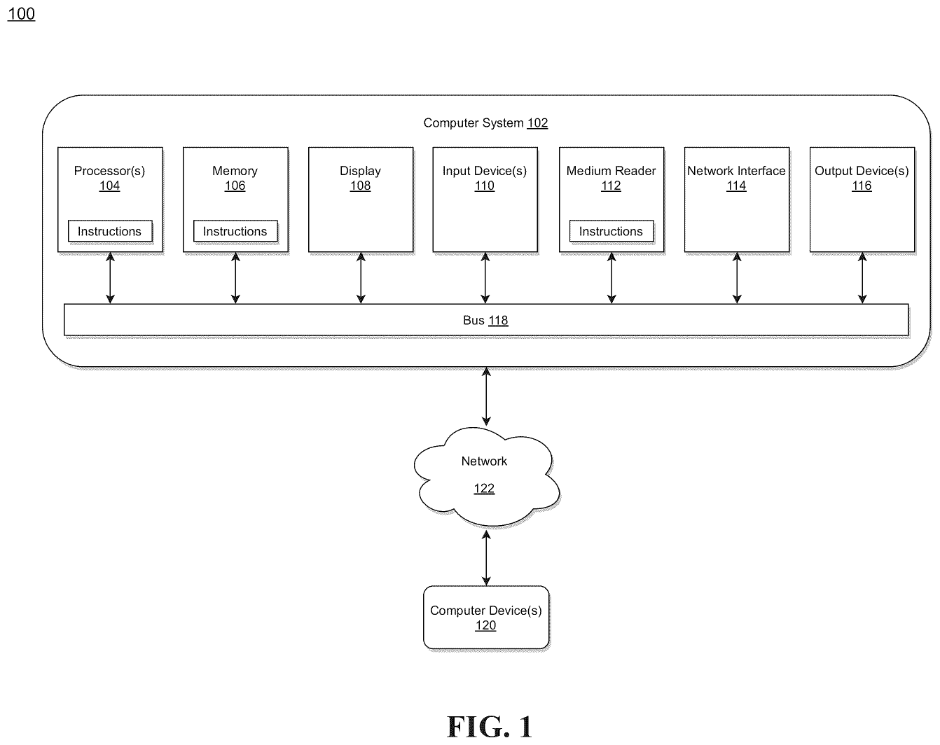

FIG. 1 illustrates a computer system for implementing an automated user interface personalization (AUIP) system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

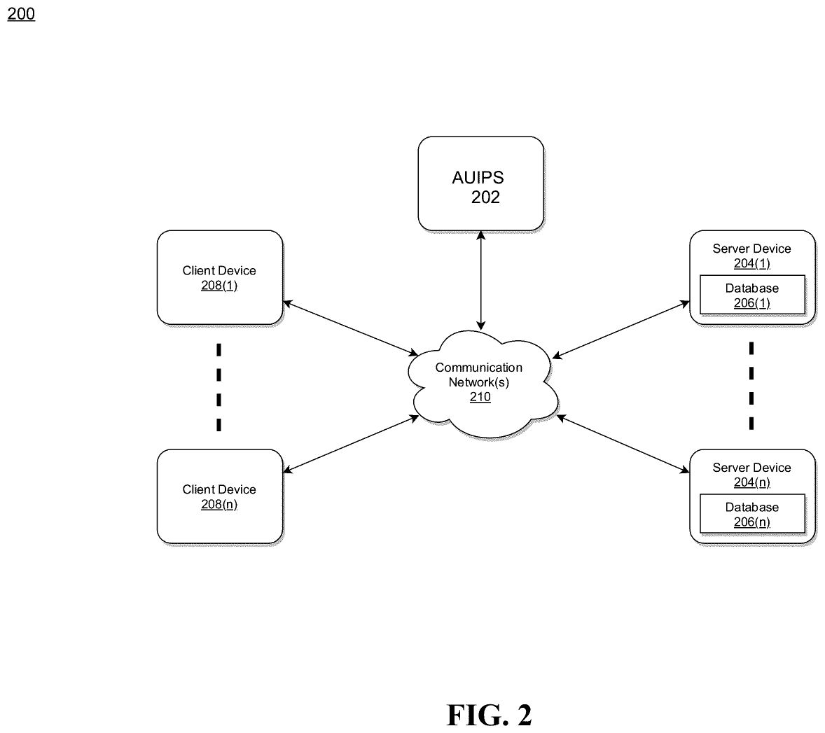

FIG. 2 illustrates an exemplary diagram of a network environment with an AUIPS in accordance with an exemplary embodiment.

An AUIPS 202 may be implemented with one or more computer systems similar to the computer system 102 as described with respect to FIG. 1.

The AUIPS 202 may store one or more applications that can include executable instructions that, when executed by the AUIPS 202, cause the AUIPS 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the AUIPS 202 itself, may be located in virtual server(s) running in a cloud-based computing environment rather than being tied to one or more specific physical network computing devices. Also, the application(s) may be running in one or more virtual machines (VMs) executing on the AUIPS 202. Additionally, in one or more embodiments of this technology, virtual machine(s) running on the AUIPS 202 may be managed or supervised by a hypervisor.

In the network environment 200 of FIG. 2, the AUIPS 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the AUIPS 202, such as the network interface 114 of the computer system 102 of FIG. 1, operatively couples and communicates between the AUIPS 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AUIPS 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AUIPS 202 may be a standalone device or integrated with one or more other devices or apparatuses, such as one or more of the server devices 204(1)-204(n), for example. In one particular example, the AUIPS 202 may be hosted by one of the server devices 204(1)-204(n), and other arrangements are also possible. Moreover, one or more of the devices of the AUIPS 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AUIPS 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the AUIPS 202 that may efficiently provide a platform for implementing a cloud native AUIPS module, but the disclosure is not limited thereto.

The client devices 208(1)-208(n) may run interface applications, such as standard web browsers or standalone client applications, which may provide an interface to communicate with the AUIPS 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the AUIPS 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AUIPS 202, the server devices 204(1)-204(n), or the client devices 208(1)-208(n), for example, may be configured to operate as virtual instances on the same physical machine. For example, one or more of the AUIPS 202, the server devices 204(1)-204(n), or the client devices 208(1)-208(n) may operate on the same physical device rather than as separate devices communicating through communication network(s) 210. Additionally, there may be more or fewer AUIPS 202, server devices 204(1)-204(n), or client devices 208(1)-208(n) than illustrated in FIG. 2. According to exemplary embodiments, the AUIPS 202 may be configured to send code at run-time to remote sever devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

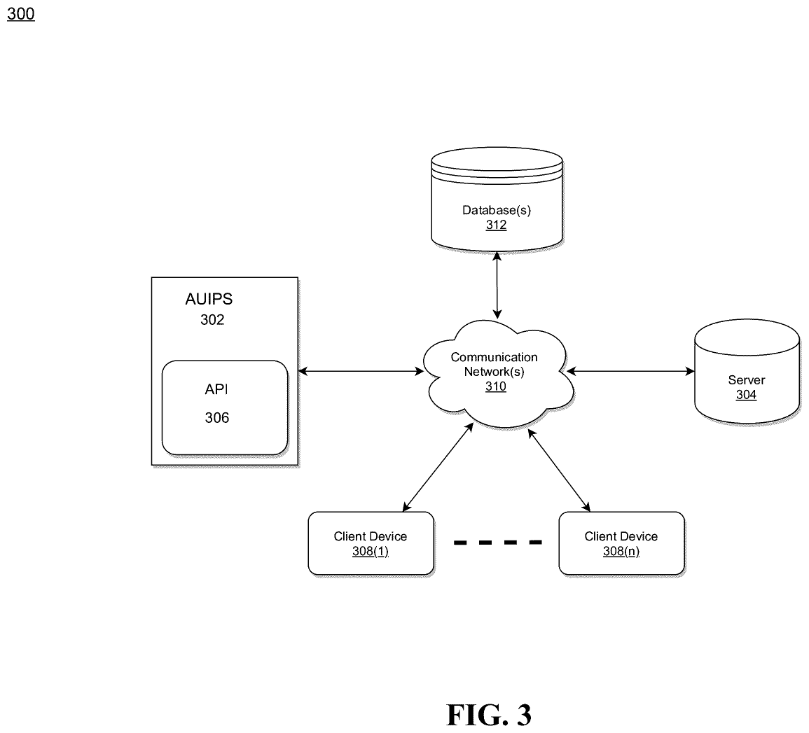

FIG. 3 illustrates a system diagram for implementing an AUIPS in accordance with an exemplary embodiment.

As illustrated in FIG. 3, the system 300 may include an AUIPS 302 within which a group of API modules 306 is embedded, a server 304, a database(s) 312, a plurality of client devices 308(1) . . . 308(n), and a communication network 310.

According to exemplary embodiments, the AUIPS 302 including the API modules 306 may be connected to the server 304, and the database(s) 312 via the communication network 310. Although there is only one database that has been illustrated, the disclosure is not limited thereto. Any number of databases may be utilized. The AUIPS 302 may also be connected to the plurality of client devices 308(1) . . . 308(n) via the communication network 310, but the disclosure is not limited thereto.

According to exemplary embodiment, the AUIPS 302 is described and shown in FIG. 3 as including the API modules 306, although it may include other rules, policies, modules, databases, or applications, for example. According to exemplary embodiments, the database(s) 312 may be embedded within the AUIPS 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable AUIPS as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the AUIPS 302. In this regard, the plurality of client devices 308(1) . . . 308(n) may be “clients” of the AUIPS 302 and are described herein as such. Nevertheless, it is to be known and understood that the plurality of client devices 308(1) . . . 308(n) need not necessarily be “clients” of the AUIPS 302, or any entity described in association therewith herein. Any additional or alternative relationship may exist between either or both of the plurality of client devices 308(1) . . . 308(n) and the AUIPS 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the AUIPS 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The AUIPS 302 may be the same or similar to the AUIPS 202 as described with respect to FIG. 2, including any features or combination of features described with respect thereto.

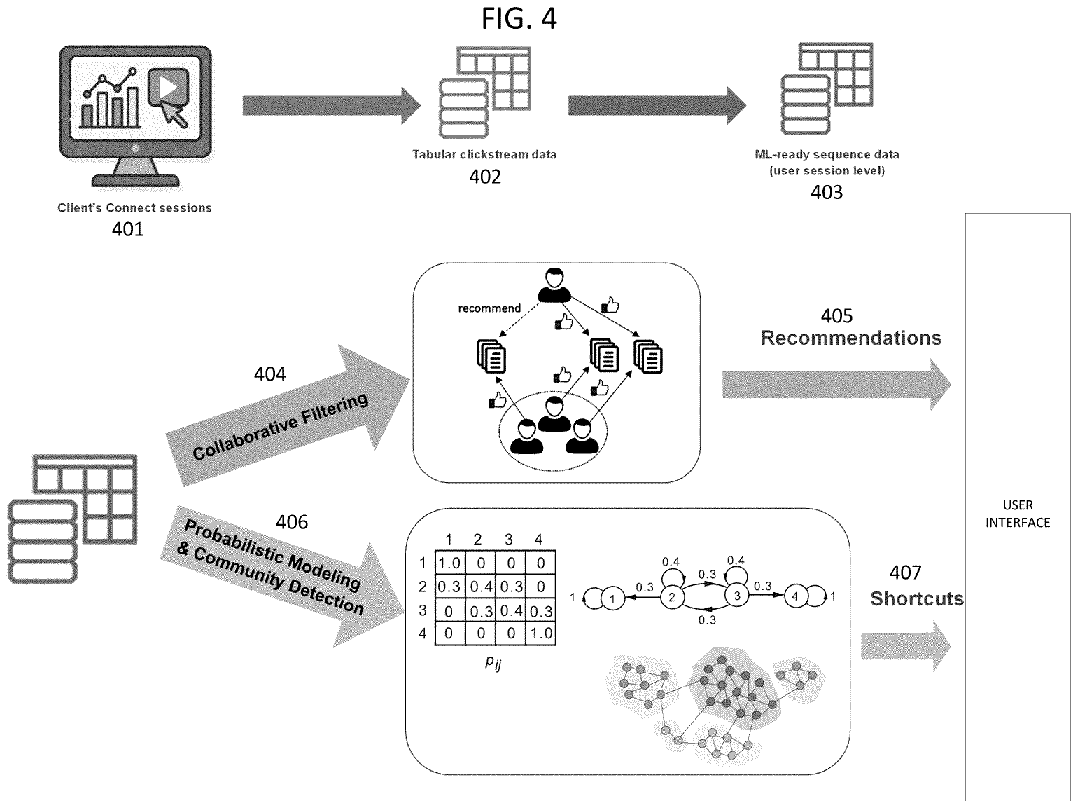

FIG. 4 illustrates a process for providing an automated user interface personalization in accordance with an exemplary embodiment.

In operation 401, historical web session data (or web data) for various users is collected over a predetermined period. In an example, the predetermined period may include most recent month, quarter, 6 months, 1 year, 2 years or the like. Further, the predetermined period may be a user selected value. According to exemplary aspects, historical web session data may include, without limitation, user identification data, time stamp and duration for a webpage visited or accessed during a web session, and all of the webpages visited during the web session. In an example, a web session may include all of the individual webpages visited, links clicked, actions taken and the like by a user after logging into a website. More specifically, for each action performed by a user, a profile identifier (ID) for the user may be logged along with a corresponding Uniform Resource Locator (URL) of the webpage visited by the user, a description of the page action performed, session ID and an event timestamp. However, aspects of the present disclosure are not limited thereto, such that a web session may not require a login and additional or different data set may be collected.

In an example, the profile ID may include a combination of numbers or alphanumeric characters corresponding to each user accessing the website or portal. Description of the page action may indicate an action performed by the user, such as logon or clicking of a particular link or webpage. Session ID may correspond to a unique identifier for the logged-in session for a particular user. Lastly, event time stamp may indicate a date and time at which a particular URL was selected or a particular action was performed by the user. However, aspects of the present disclosure are not limited thereto, such that duration at a particular webpage may also be tracked.

According to exemplary aspects, webpages visited may be associated with one or more products, subject, category or the like.

In operation 402, the collected web data may undergo one or more data enhancement and consolidation operations. According to exemplary aspects, webpages or URLs may be categorized according to a product and/or page type for generation of multiple categories of products and/or webpages. In another example, the categories and corresponding actions performed on corresponding webpages may be combined for creating a unique identifier. Further, some or all session activities may be grouped into sequential user path. Lastly, session activity may be displayed or organized by profile ID and/or session ID. However, aspects of the present disclosure are not limited thereto, such that additional or different data enhancement or consolidation operations may be performed on the collected web data. The processed data may then be formatted as tabular clickstream data for further processing in operation 403.

In operation 403, the enhanced and/or consolidated data may be further processed or formatted for providing machine learning (ML) or artificial intelligence (AI) ready sequence data. For example, the ML-ready sequence data may be prepared at a user session level and may be of a predetermined size, for example, 300K sessions. The ML formatted data may be utilized for generating, training and/or modifying or updating a machine learning model. Although FIG. 4 illustrates that operation 403 is performed subsequent to operation 402, aspects of the present disclosure are not limited thereto, such that formatting of the collected historical web session data may be performed subsequent to operation 401.

In an example, AI or ML algorithms may be generative, in that the AI or ML algorithms may be executed to perform data pattern detection, and to provide an output based on the data pattern detection. More specifically, an output may be provided based on a historical pattern of data, such that with more data or more recent data, more accurate outputs may be provided. Accordingly, the ML or AI models may be constantly updated after a predetermined number of runs or iterations are initially performed to provide initial training. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, N-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a N-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment the ML or AI models may be generated using at least one from among an artificial neural network technique, a decision tree technique, a support vector machines technique, a Bayesian network technique, and a genetic algorithms technique.

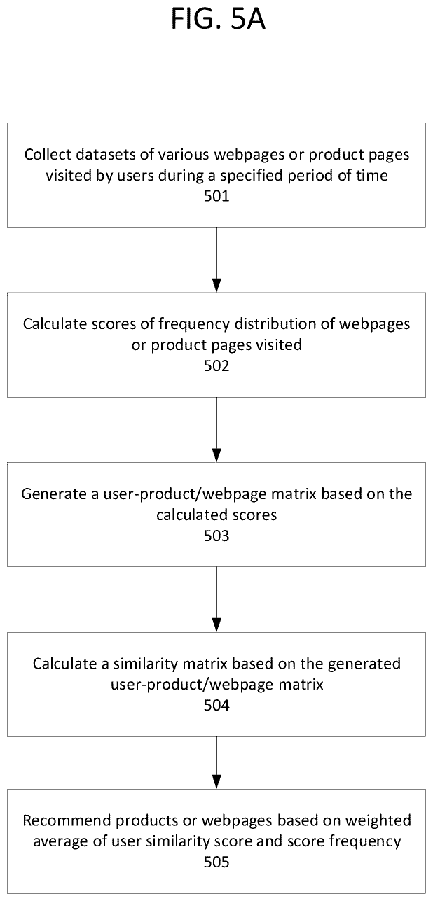

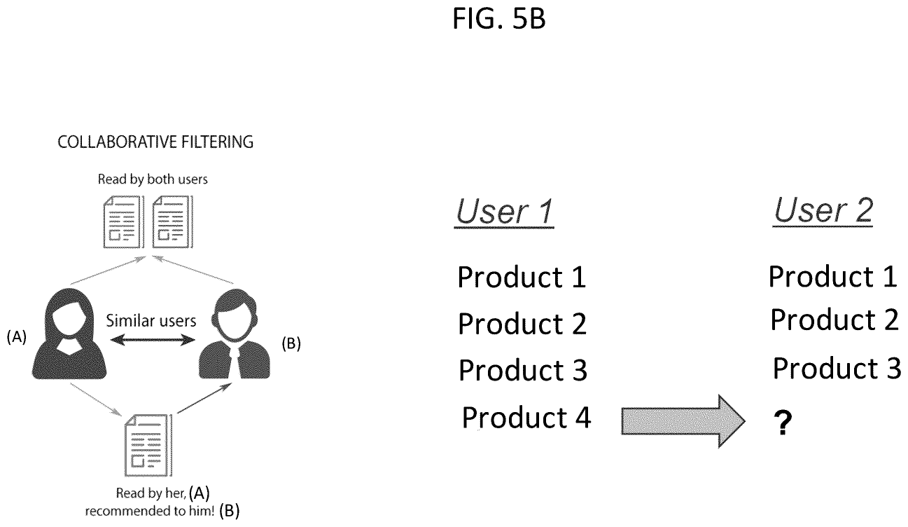

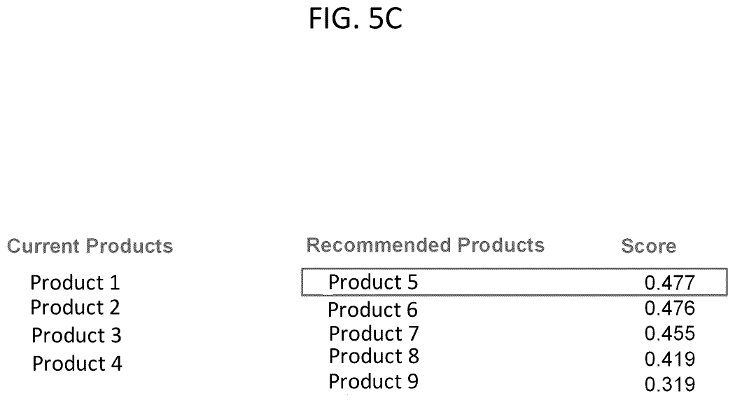

In operation 404, the ML-ready sequence data may be processed for performing collaborative filtering, which is described in more detail below in view of FIGS. 5A-5C may be performed using one or more ML or AI algorithms. According to exemplary aspects, collaborative filtering allows the AUIPS to identify similar users based on similarity in historical web session data of various users and/or usage or subscription to common products or webpages. For example, when a user X and a user Y both use products A, B and C and have similar historical web session data, the user X and user Y may be identified as similar users via the collaborative filtering process. Upon identification of similar users or similarity matrix, a product or webpage that a target user is not utilizing or subscribed to, which another user identified as being similar is using, may be presented to the target user as a recommendation.

In operation 405, one or more product recommendations may be generated based on the collaborative filtering and placed on a user interface for display or access. According to exemplary aspects, the user interface may be dynamically modified to create a space for insertion of the one or more product recommendations. Further, the one or more product recommendation may be provided as a direct hyperlink and/or may include a descriptive suggestion. The one or more product recommendation may additionally be highlighted or shown in a distinct color to direct the user's focus to the recommendations.

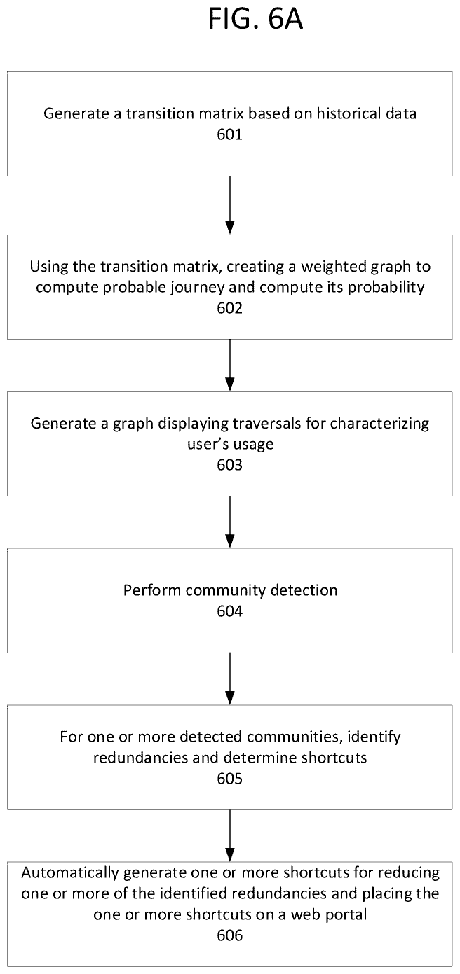

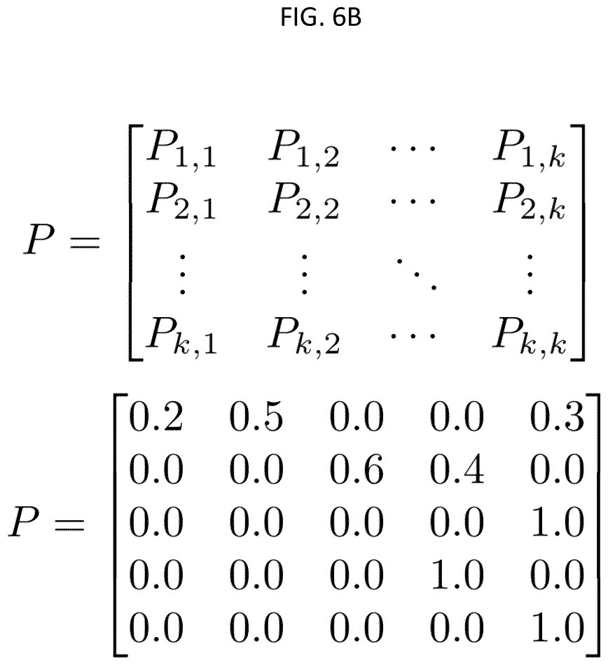

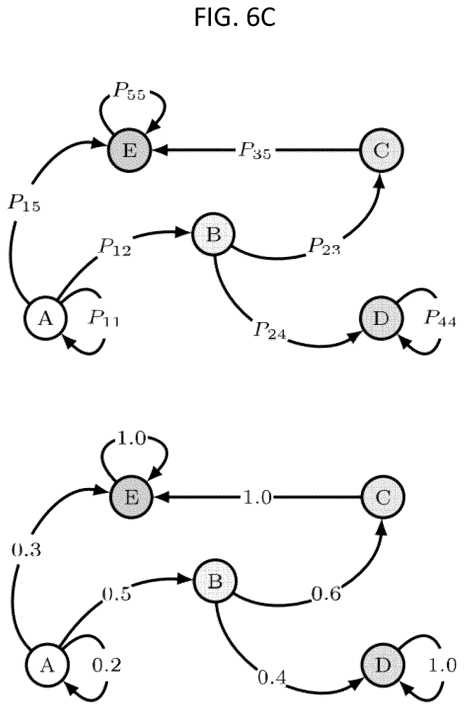

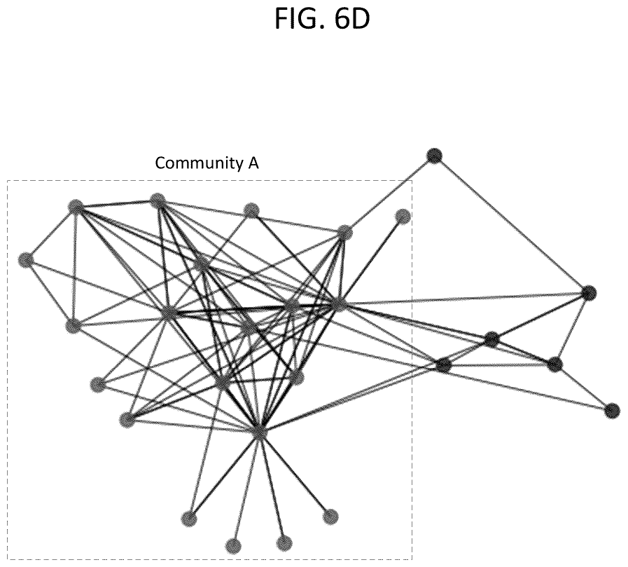

In operation 406, probabilistic modeling and community detection processing are performed, which is described in more detail below in view of FIGS. 6A-6D. According to exemplary aspects, a probabilistic model of a transition path of a target user may be generated based on the historical web session data for the target user. Based on the probabilistic model, a probable journey across various webpages may be determined and graphed. Based on the graphed probable journey of the target user, which may be represented by traversal paths across various nodes representing various webpages, one or more communities may be identified based on proximate distances between adjacent nodes. In an example, if the proximate distance is determined to be equal or lower than a reference value, it may be determined that the respective nodes belong to the same community. Once one or more communities are identified, one or more redundancies may be identified within the one or more communities for creating a shortcut to avoid navigating through unnecessary nodes. In another words, a new webpage transition path may be generated.

In operation 407, one or more shortcuts may be generated based on the probabilistic modeling and community detection and placed on a user interface for display or access. According to exemplary aspects, the user interface may be dynamically modified to create a space for insertion of the one or more shortcuts. Further, the one or more shortcuts may be provided as a direct hyperlink, icon, menu selection or the like. The one or more shortcuts may additionally be highlighted or shown in a distinct color to direct the user's focus to the shortcuts.

FIGS. 5A-5C illustrate a process for performing collaborative filtering in accordance with an exemplary embodiment.

As illustrated in FIG. 5A, collaborative filtering may be performed to identify similar users for targeted recommendation of products based on product page visitation. In operation 501, user visit data from various product pages during a specified period of time are collected. In an example, an operator may specify the time period of interest or specify a range of period (e.g., last 6 months). Alternatively, the time period of interest may be automatically set or may be cumulative. In operation 502, scores for frequency distribution of r product pages are calculated. For example, if product pages corresponding to product A are visited more than product pages corresponding to product B, product A will have a higher score.

In operation 503, a user-product page matrix is generated based on the scores calculated in operation 502. In an example, the user-product matrix may include a matrix of product pages that were visited based on frequency of visits. Each value in the matrix corresponds to a product page that was visited by the user.

In operation 504, a similarity matrix is calculated based on the generated user-product page matrix. In an example, the similarity matrix may indicate a similarity of various users. Lastly, in operation 505, one or more products may be recommended based on weighted average of user similarity score and score frequency.

For example, as illustrated in FIG. 5B, the collaborative filtering may identify users that may have viewed same product pages. Based on similar viewing history, one or more product pages that were viewed by user A but not by user B may be recommended to user B. In another example, if user 1 and user 2 are determined to be similar users based on their respective viewing history, and if user 1 viewed webpages or materials related to product 1, product 2, product 3 and product 4, while user 2 viewed webpages or materials related to product 1, product 2 and product 3 only, product 4 may be recommended to user 2.

Further, as exemplarily illustrated in FIG. 5C, when multiple products (product 5, product 6, product 7, product 8, and product 9) are available for recommendation to a user already utilizing product 1, product 2, product 3 and product 4, product recommendation may be provided based on a calculated similarity score. As illustrated in FIG. 5C, product 5 may be selected as a recommended product based on the calculated similarity score. Although one recommended product is illustrated as being selected for recommendation, multiple products may be recommended in a descending order based on the calculated similarity scores.

FIGS. 6A-6D illustrate a process for performing probabilistic modeling and community detection in accordance with an exemplary embodiment.

In operation 601, a transition matrix is generated based on historical data of webpages visited in sequence according to user session. For example, the historical data may indicate that user 1 started a user session and visited webpage A, then transitioned to webpages B, C and D in respective order prior to logging out of the user session. Webpage transition path may be stored in a database and may be graphically generated as exemplarily provided in FIG. 6C, where the node represents the website, the directed edge between two nodes (A and B) represents possible navigation from website A to website B, and the edge label represents the estimated probability that user 1 will visit website B after having immediately visited website A.

As exemplarily illustrated in FIG. 6B, the transition matrix is a square matric in which each element indicates the probability of node-to-node transition. According to exemplary aspects, each node may correspond to a particular webpage. For example, given a user is currently on webpage A, P_{1,1} may indicate the probability that the user remains on webpage A, while P_{1,2} may indicate the probability that the user transitions to webpage B, and so on. (If P_{1,k} is 0, this reflects that one cannot transition directly from webpage A to the k-th webpage.)

In operation 602, a weighted graph may be created using the transition matrix to compute a probable journey and its probability. For example, as illustrated in FIG. 6C, if the historical data indicates that the user transitions from webpage A to webpage B 50 out of 100 times, then transitions from webpage B to webpage C 60 out of 100 times, and finally transitions from webpage C to webpage E 100 out of 100 times, then a probable journey may be a sequential visit from webpage A, to webpage B, to webpage C and finally to webpage E, with 0.30 probability.

As illustrated in FIG. 6C, a particular user may have transitioned from node or webpage A to either one of node B with probability 0.5 (50% of the time) or node E with probability 0.3 (30% of the time), or stay within node A with probability 0.2 (20% of the time).

In operation 603, a graph may be generated to display traversals for characterizing user's usage as exemplarily illustrated in FIG. 6D. As exemplarily illustrated in FIG. 6D, a user's navigation path history may be graphically displayed, which may provide visual indication of user's focus. More specifically, based on the traversal graph of FIG. 6D, it may be seen that the respective user may spend most of his or her time navigating through nodes or webpages within the dashed box and seldom visit webpages outside of the dashed box. The two groups of nodes or webpages may be identified as separate communities.

In operation 604, community detection is performed based on the generated traversal graph. According to exemplary aspects, community detection may be performed based on proximate distance of nodes. In FIG. 6D, nodes within the dashed box may represent one community (i.e., Community A), while nodes outside of the dashed box may belong to another community.

In operation 605, for the one or more detected communities, various redundancies are then identified and shortcuts may be determined. For example, if it can be seen that user normally travels from node A to node D, and traverses through node B and C just to get to node D, a short cut from node A to node D may be established for more efficient navigation and to reduce network traffic.

In operation 606, one or more shortcuts are then generated for reducing one or more of the identified redundancies and the one or more shortcuts are then provided on a web portal for direct access. According to exemplary aspects, the one or more shortcuts may be provided as a hyperlink, a menu selection, an icon, or the like for providing one click access to the destination node of the shortcut.

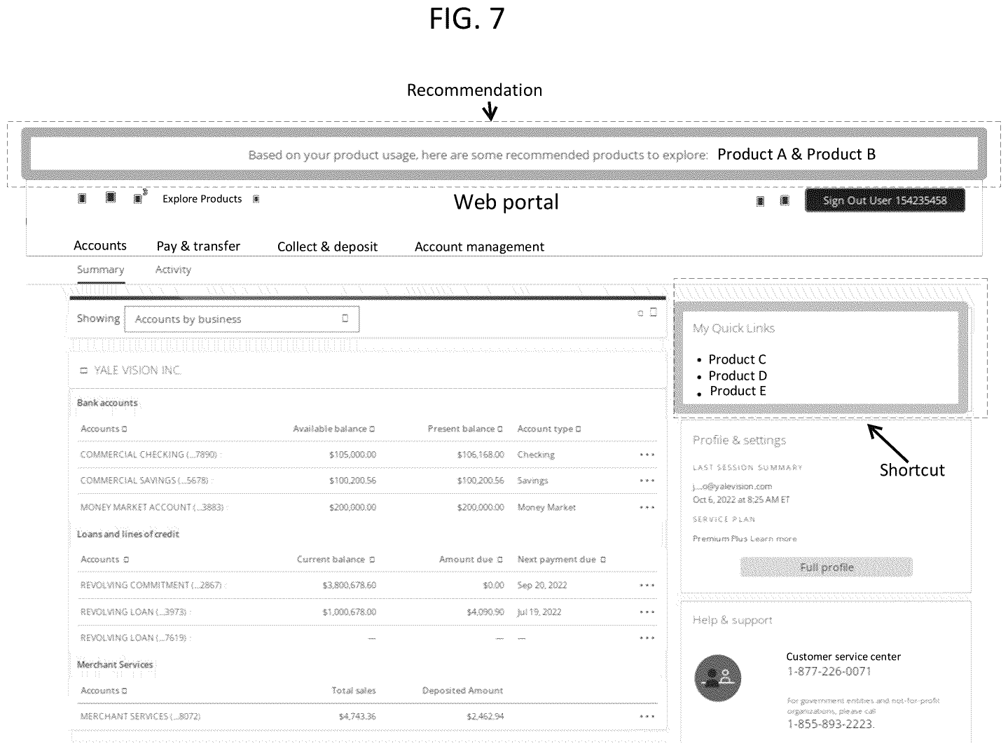

FIG. 7 illustrates a personalized web portal in accordance with an exemplary embodiment.

FIG. 7 may provide a display of an exemplary web portal page or a default webpage that may be displayed to a user after logging in with user credentials, such as username and password. According to exemplary aspects, the default webpage for a new user may not display a recommendation portion and/or shortcut portion illustrated in dashed boxes in FIG. 7 as no user webpage transition history may be available. However, once sufficient user webpage transition history becomes available, one or more of collaborative filtering, probabilistic modelling and community detection processing may be performed for generating one or more recommendations and/or shortcuts. Upon generation of the recommendations and shortcuts, the default webpage or portal for the respective user may be dynamically modified to insert a recommendation section and/or a shortcut section to provide a webpage layout that is different from other users. Accordingly, a customized webpage layout that is specific to the respective user may be provided that incorporates the aforementioned recommendation section and/or shortcut section in a user-friendly format.

Although insertions of new sections within the webpage are illustrated in FIG. 7, aspects of the present disclosure are not limited thereto, such that one or more of the recommendations or shortcuts may be provided as a pop-up, a new menu option, a new link provided on an existing webpage layout, a highlighted item, or the like to alert the user of available options.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for dynamically customizing a webpage layout according to webpage transition history of a user, the method comprising:
collecting, via a network, historical web session data of a plurality of users;
storing, in a memory, the collected historical web session data;
executing, by a processor, collaborative filtering using the collected historical web session data;
generating, by the processor executing a machine learning (ML) algorithm, a probabilistic model;
generating, by the processor, a webpage transaction path for a target user among the plurality of users;
identifying, by the processor, one or more communities within the webpage transaction path;
generating, by the processor, at least one webpage recommendation for the target user based on the collaborative filtering;
generating, by the processor, at least one webpage shortcut for the target user based on the probabilistic model and the identified one or more communities within the webpage transaction path;
modifying, by the processor, a default webpage layout to include the at least one webpage recommendation and the at least one webpage shortcut; and
displaying, on a display, the modified webpage layout including the at least one webpage recommendation and the at least one webpage shortcut.

2. The method according to claim 1, further comprising:
categorizing of webpages visited in the historical web session data according to a webpage type into a plurality of categories of webpages; and
combining the plurality of categories of webpages for generating a unique identifier.

3. The method according to claim 1, further comprising:
categorizing of webpages visited in the historical web session data according to a product type into a plurality of categories of products; and
combining the plurality of categories of products for generating a unique identifier.

4. The method according to claim 1, further comprising:
formatting the collected historical web session data into a ML-ready sequence data for processing for the ML model.

5. The method according to claim 4, wherein the processing for the ML includes generating the ML model, training the ML model and updating the ML model.

6. The method according to claim 1, wherein the modifying of the default webpage layout includes inserting a section to include the at least one webpage recommendation.

7. The method according to claim 1, wherein the modifying of the default webpage layout includes inserting a section to include the at least one webpage shortcut.

8. The method according to claim 1, wherein the at least one webpage recommendation or the at least one webpage shortcut is provided as a hyperlink or a menu option.

9. The method according to claim 1, wherein the at least one webpage shortcut is generated based on identification of redundancies within the one or more communities, and wherein the at least one webpage shortcut is configured to allow the target user to navigate directly to a webpage corresponding to the at least one webpage shortcut without visiting intervening webpages.

10. The method according to claim 1, wherein the webpage transaction path includes a sequential order in which a plurality of webpages were visited by the target user.

11. The method according to claim 10, wherein the webpage transaction path is formed of a plurality of nodes, each of the plurality of nodes corresponding to each of the plurality of webpages visited by the target user.

12. The method according to claim 11, wherein the one or more communities are identified based on proximate distances between adjacent nodes among the plurality of nodes.

13. The method according to claim 11, wherein the webpage transaction path indicates a probability of transitioning from one node to another node among the plurality of nodes.

14. The method according to claim 1, wherein the collaborative filtering includes:
calculating scores of frequency distribution of webpages visited by the target user;
generating a user-webpage matrix based on the calculated scores; and
calculating a similarity matrix based on the generated user-webpage matrix for generating the at least one webpage recommendation.

15. The method according to claim 1, wherein the generating of the probabilistic model includes:
generating a transition matrix of the target user based on the historical web session data;
creating a weighted graph for computing a probable journey using the transition matrix; and
generating a graph displaying traversals that characterizes the target user's webpage usage.

16. The method according to claim 14, wherein the at least one webpage recommendation includes a webpage that the target user has not yet visited but another user in the similarity matrix has.

17. The method according to claim 15, wherein the webpage that the target user has not yet visited provides information for a product.

18. The method according to claim 1, wherein the at least one webpage recommendation is selected for recommendation based on its score.

19. A system to provide for dynamically customizing a webpage layout according to webpage transition history of a user, the system comprising:
a memory;
a display; and
a processor configured to perform:
collecting, via a network, historical web session data of a plurality of users;
storing the collected historical web session data;
executing collaborative filtering using the collected historical web session data;
generating, via a machine learning (ML) algorithm, a probabilistic model;
generating a webpage transaction path for a target user among the plurality of users;
identifying one or more communities within the webpage transaction path;
generating at least one webpage recommendation for the target user based on the collaborative filtering;
generating at least one webpage shortcut for the target user based on the probabilistic model and the identified one or more communities within the webpage transaction path;
modifying a default webpage layout to include the at least one webpage recommendation and the at least one webpage shortcut; and
displaying, on a display, the modified webpage layout including the at least one webpage recommendation and the at least one webpage shortcut.

20. A non-transitory computer readable storage medium that stores a computer program for dynamically customizing a webpage layout according to webpage transition history of a user, the computer program, when executed by a processor, causing a system to perform a plurality of processes comprising:
collecting, via a network, historical web session data of a plurality of users;
storing the collected historical web session data;
executing collaborative filtering using the collected historical web session data;
generating, via a machine learning (ML) algorithm, a probabilistic model;
generating a webpage transaction path for a target user among the plurality of users;
identifying one or more communities within the webpage transaction path;
generating at least one webpage recommendation for the target user based on the collaborative filtering;
generating at least one webpage shortcut for the target user based on the probabilistic model and the identified one or more communities within the webpage transaction path;
modifying a default webpage layout to include the at least one webpage recommendation and the at least one webpage shortcut; and
displaying, on a display, the modified webpage layout including the at least one webpage recommendation and the at least one webpage shortcut.
